(19) United States
(12) Patent Application Publication
(10) Pub. No.: US 2002/0017990 A1
(43) Pub. Date: Feb. 14, 2002

(54) Distribution system

(76) Inventor: Eiji Okamura, Tokyo (JP)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 09/746,846

(22) Filed: Jun. 22, 2001

(30) Foreign Application Priority Data
Jul. 19, 2000 (JP) 2000-219821

(51) Int. Cl. G08B 13/14

(52) U.S. Cl. 340/572.1; 340/568.1; 340/571

(57) ABSTRACT

Objective: To offer a distribution system that can immediately confirm a product within a package without opening the package [sic].

Means for Achieving Objective: The invention comprises a shipping site 1, a receiving site 2, and a distribution network 3; to a package 4 that is shipped over the distribution network 3 is attached an electronic tag 5 in which data specifying a product 9 contained therein and data on quantity and price are stored; and to the product 9 packed in the package 4 is attached an electronic tag 10 in which data corresponding to the product is stored. At the shipping site 1, data that specifies the product 9 within the package 4 is stored in the electronic tag 5 attached to the package 4; at the receiving site 2, data in the electronic tag 5 and data in the electronic tag 10 attached to the product in the package 4 are read by a reader, and by comparing the two sets of data, confirmation can be easily performed without opening the package to determine whether the contents of the package 4 at the shipping site 1 match the contents of the package 4 shipped to the receiving site 2.

### FIELD OF THE INVENTION

The present invention relates to a distribution system which delivers clothing fabric, clothing, shoes, handbags, wallets, jewelry, precious metals, accessories, cash, securities, and the like, and in particular relates to a distribution system in which an electronic tag is attached to a package, and an electronic tag is attached to a product inside the package.

### BACKGROUND OF THE INVENTION

In the retailing of clothing, shoes, handbags, wallets, fashion clothing, dry goods, and the like, a large variety of items are displayed and segmented in a retail shop according to their design, color, size and the like. In addition, these items are also stored in the shop's storeroom as inventory items. The search and retrieval of inventory items is becoming an essential service, because it is necessary to provide a desired product immediately in response to customer demand.

However, in retail shops, one must give priority to the practical use of the display area intended for the customer. Thus, the size of the storeroom inside the shop is restricted, and it is difficult to arrange and store inventory items according to type, design, color, size, and the like.

In addition, inventory control becomes complicated due to the fact that popular products such as fashion clothing, dry goods, and the like change frequently and the shop inventory is always being rotated between production facilities and long-term storage warehouses.

Further, even with the delivery of those products, classifying the products into separate types, designs, colors, and sizes and individually packaging them causes an increase in the number of packages, and brings about a reduction in delivery efficiency.

Accordingly, a plurality of products with different types, designs, colors, sizes, and the like that are intended for a retail shop and its storeroom are now combined into one package, and a packing list showing the details of each and every product stored in the package is attached thereto.

A prior art distribution system in which a combination package is used and a packing list is attached thereto, for example like that shown in FIG. 5, is composed of a shipping site 1 having a data processing device 111 which includes a send and receive function, a receiving site 2 having data processing device 112 which includes a send and receive function and a printer 13, a distribution network 3, and communications network 12. At shipping site 1, packing list 141 will be attached to package 4 to be sent to receiving site 2 via distribution network 3. The list of the package contents is transmitted to receiving site 2 via communication network 12. Then, at shipping site 1, products that are to be sent to receiving site 2 are prepared and stored in package 4 according to packing list 141. Packing list 141 is then attached to package 4, and is delivered to receiving site 2 via distribution network 3.

At shipping site 1, when data on the contents of package 4 is transmitted by data processing device 111 via communication network 12, it is received by data processing device 112 at receiving site 2. After that, it is printed out as packing list 142 by printer 13.

When the staff at the receiving site examines the package 4 that has been sent, they validate package 4 by comparing the packing list 142 that was transmitted to them with the packing list 141 attached to package 4. After that, they open package 4, and a number examination occurs by comparing the contents listed on packing list 141 or 142 with the products in the package.

In a number examination of the products packed for shipping, packages are opened one by one, and the items therein are confirmed by comparing them with the voucher. These number examinations are very time consuming and expensive because they involve opening packages.

In particular, if the product is high quality clothing, there are those that absolutely want the contents to be confirmed at each step of the process, beginning at the shipping site, and then at the receiving site, and of course at each transit point during shipping. This is due to the fact that the product is very expensive.

However, it frequently takes effort to open and inspect the packages, and there is a danger that the product will be damaged or soiled. This is not desirable.

In particular, when cash and securities, and the like, are handled, the work of opening the package to confirm the contents and the sum of money therein is dangerous because there is an increased chance of robbery. That is, with an expensive item such as high quality fabric, high quality clothing, high quality shoes, a high quality wallet, jewelry, precious metal, an accessory, cash, securities and the like, and with intangible products having various values, it takes work to confirm the number of products, and moreover, when damage, soiling, and robbery is encountered, there is a fear that large amounts of compensation will have to be paid.

### BRIEF SUMMARY OF THE INVENTION

Accordingly, it is considered to be an object of the present invention to provide a distribution system that can instantly confirm the products inside a package without opening it.

The distribution system according to the present invention includes a shipping site, a receiving site, and a distribution network. An electronic tag is attached to a package shipped via this distribution network, the electronic tag having data to identify the products in the package, and quantity or price data, stored thereon. An electronic tag is also attached to each product inside the package and has data relating to the product stored thereon.

Then, at the shipping site, data on the product placed inside the package is stored on the electronic tag attached to the package, and at the receiving site, both the data on the electronic tag and the data on the electronic tag attached to the product in the package are read by a read/write device. By comparing both sets of data, the similarity of the contents of the package at the shipping site and the contents of the package shipped to the receiving site can be easily confirmed without opening the package.

### BRIEF DESCRIPTION OF DRAWINGS

FIG. 1 showing an embodiment of the distribution system of the invention.

FIG. 2 showing a package and products to which electronic tags used in the distribution system of the invention are attached.

FIG. 3 showing one example of a record of an electronic tag attached to the product of the invention.

FIG. 4 showing one example of a record of an electronic tag attached to the package of the invention.

FIG. 5 showing one example of a conventional distribution system.

### DETAILED DESCRIPTION OF EMBODIMENTS OF THE INVENTION

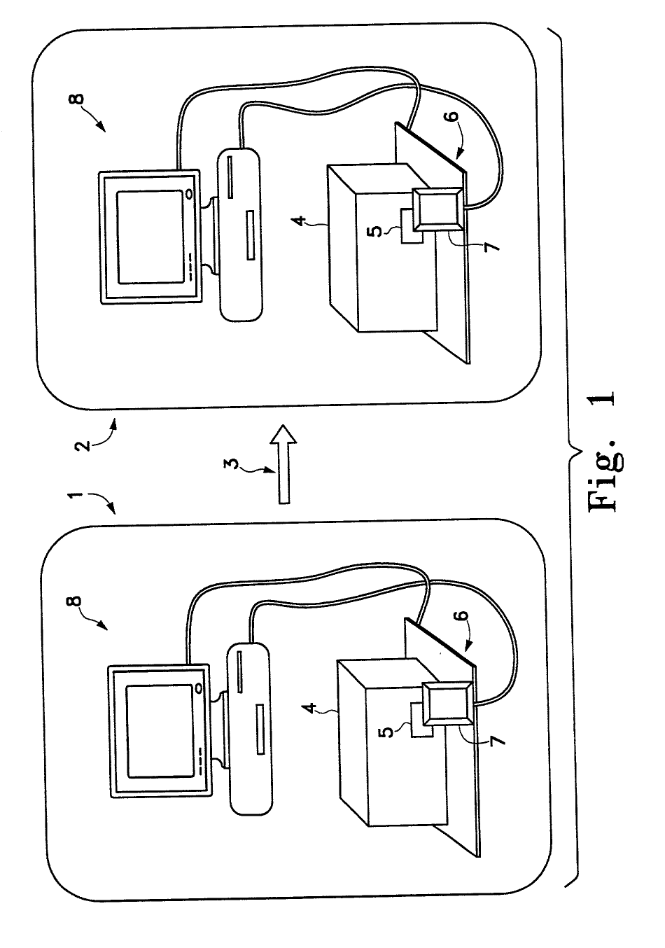

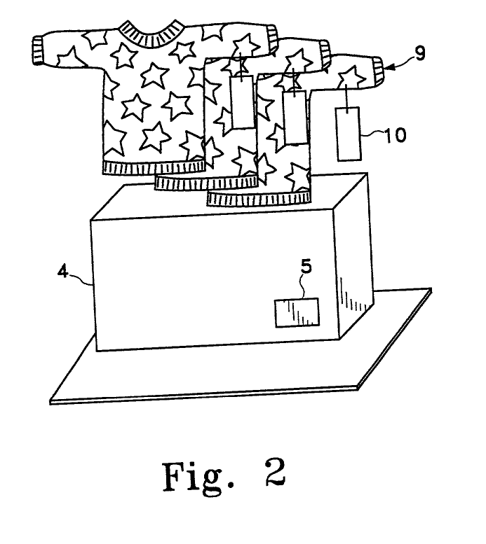

The distribution system of the present invention, as shown in FIG. 1, is composed of a shipping site 1, a receiving site 2, and a distribution network 3. As shown in FIG. 2 (products 9 and electronic tags 10 are removed from package 4 for clarity), electronic tag 5 is attached to package 4 to be shipped, and in addition, an electronic tag 10 is attached to each product 9 to be placed in package 4.

The composition of shipping site 1 and receiving site 2 is approximately the same. They are composed of an electronic tag read/write device 7 for reading from and writing to electronic tag 5 attached to package 4, an electronic tag reading device 6 for reading electronic tags 10 attached to products 9 placed in package 4 (as shown in FIG. 2), and a controller 8 for controlling the operation of electronic tag read/write device 7 and electronic tag reading device 6 connected thereto.

As shown in FIG. 1, electronic tag reading device 6 for reading electronic tag 10 attached to product 9 is flat shaped, and each electronic tag 10 can be read when disposed in package 4.

Electronic tags 5 and 10 are electronic tags composed of electrical elements, and have a large storage capacity. The storage capacity can be easily overwritten electronically from outside the electronic tag. And, because they are lightweight, attaching them to packages used in general distribution and to products does not cause any difficulties.

In addition, electronic tags 10 attached to products 9 are no-contact type wireless tags. When a specific electro-magnetic frequency is used from outside thereof and data is requested to be read out, because it outputs an ID code, one no-contact type wireless tag is specified from amongst a plurality of no-contact wireless tags by identifying and calling the ID. The stored data can be read and overwritten, and even if product 9 in package 4 is a plurality of items and/or a plurality of types, each electronic tag 10 data can be read without opening package 4 and all data relating to each product 9 can be obtained.

In the distribution system according to the present invention, package 4 with product 9 placed therein is shipped to receiving site 2 via distribution network 3 with electronic tag 5 attached to the surface thereof.

When shipping, controller 8 in shipping site 1 activates electronic tag reading device 6, which reads the data from the electronic tag 10 attached to each product 9 disposed in package 4. Details regarding data identifying product 9 and the quantity of product 9 placed in package 4 is processed and produced.

Next, the detailed data produced regarding product 9 stored in package 4 is read onto electronic tag 5 by electronic tag read/write device 7.

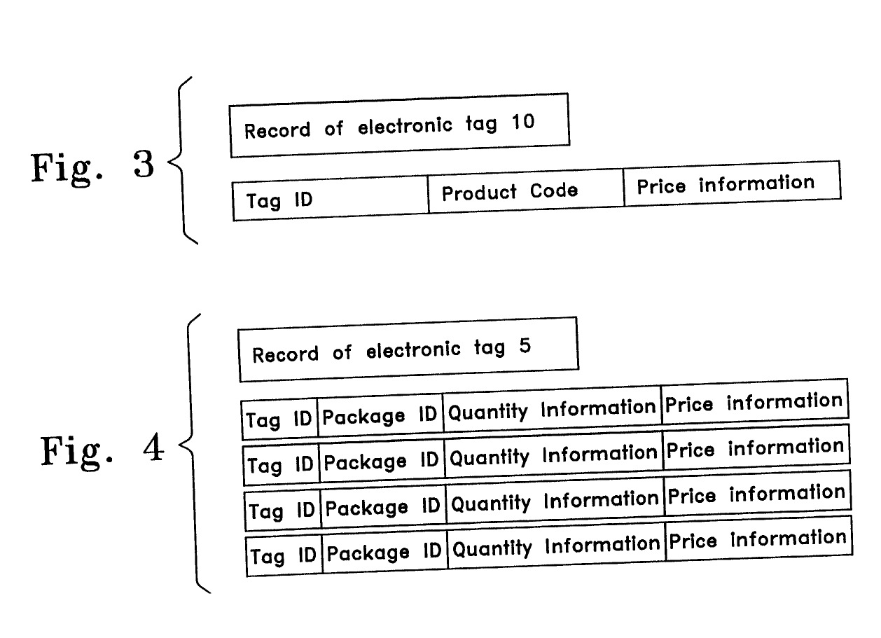

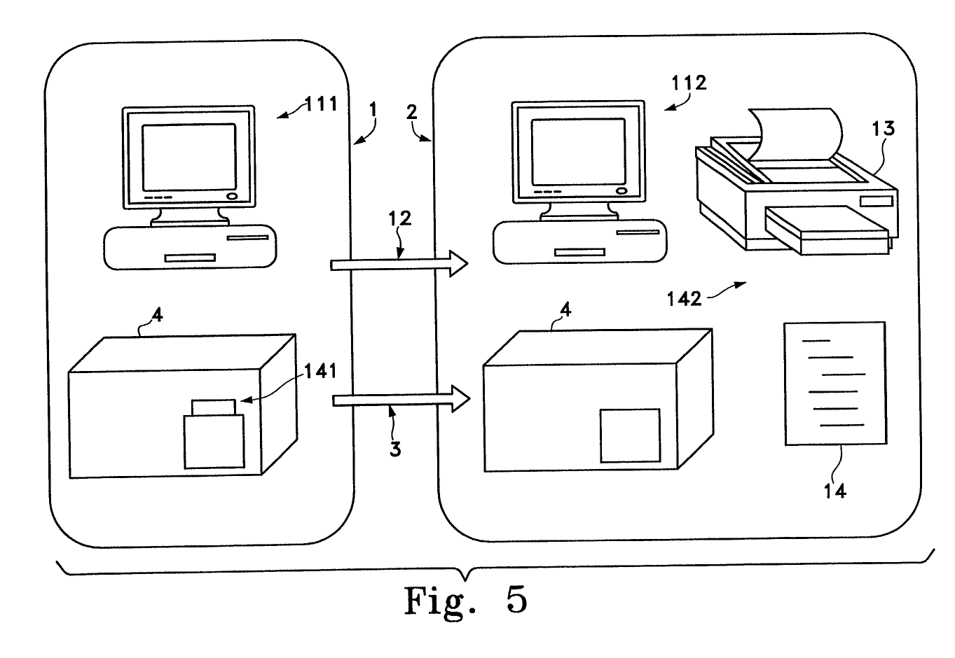

As shown in FIG. 3, the data stored on electronic tag 10 is data needed for distribution, such as the tag ID for identifying itself, the product code identifying product 9, and price data relating to the purchase price or the fixed retail price of product 9.

Further, as shown in FIG. 4, the data stored on electronic tag 5 is data showing items such as the tag ID for identifying itself, the package ID, data on the quantity of product in package 4, and product price data. This data is stored on electronic tag 5 on each package 4 containing product 9.

At receiving site 2, when package 4 is delivered, similar to shipping site 1, electronic tag reading device 6 first reads the data on electronic tag 10 attached to product 9 disposed in package 4. In addition, the data on electronic tag 5 attached to package 4 is read by electronic tag read/write device 7. At this time, it is not necessary to open package 4.

The data on electronic tag 5 and electronic tag 10 is compared by controller 8, and by confirming the similarity between the two sets of data, it can confirm that the product in package 9 is the same product that was shipped from shipping site 1.

The material composing package 4 is at least that in which electro-magnetic waves pass through the portion facing electronic tag reading device 6, and is mechanically strong. Material in which there is no difficulties when shipping valuable goods is needed.

Further, even though electronic tag 5 attached to package 4 is a no-contact type electronic tag, because electronic tag 5 is attached to the surface of package 4, a contact-type of electronic tag is acceptable, and it can be easily read and written to by read/write device 7.

Further, receiving site 2 can be a transit location and a shipping site by resending packages to the next receiving site. That is, it is possible for shipping site 1 and receiving site 2 to be interchangeable. In the transit location, the confirmation of the quantity etc. of product can be reliably conducted without opening package 4, and thus it becomes possible to ship package 4 to the next receiving site in a short amount of time.

In the distribution system according to a first embodiment of the present invention, shipping site 1 and receiving site 2 included reading device 6 and read/write device 7 for recording data on electronic tags 5 and 10. However, the composition of controller 8 can be modified and the number of connections reduced by combining devices 6 and 7 into one unit.

As is clear from the explanation based on the aforementioned embodiments, with the distribution system according to the present invention, the confirmation of products in packages at shipping site 1 and shipping site 2 can be done quickly without opening the packages. Because a comparison of the details of the contents thereof can be carried out, improvements in the work of confirming the similarity of the goods transported in the distribution system and the data relating thereto can be designed.

Further, because number examinations of packages in the transportation network can be carried out without opening them, the task of confirmation at the time of shipping can be eliminated, there are no concerns about damaging or soiling products due to unpacking and repacking, and the risk of robbery can be reduced.

In particular, there is a significant effect exhibited when shipping goods with several designs or prices or the like, and with an expensive item such as high quality fabric, high quality clothing, high quality shoes, a high quality wallet, jewelry, precious metal, an accessory, cash, securities and the like.

1. A distribution system comprising a shipping site, a receiving site, a distribution route, an electric tag attached to a package to be shipped via said distribution network, and an electronic tag attached to a product disposed in said package.

2. The distribution system according to claim 1, wherein at least one of the electric tag attached to the package and the electric tag attached to said product disposed inside the package is a no-contact type wireless tag.

3. The distribution system according to claim 1, wherein data relating to the product disposed in the package is stored on the electronic tag attached to the package.

4. The distribution system according to claim 3, wherein the data stored in the electronic tag attached to the package contains at least data for identifying the product and the quantity or price thereof.

5. The distribution system according to claim 1, wherein the product disposed in the package is at least either fabric, clothing, shoes, a handbag, a wallet, jewelry, precious metal, an accessory, cash, or a security.

6. The distribution system according to claim 1, wherein at least data corresponding to the attached item is stored on the electronic tag attached to the product.

7. The distribution system according to claim 6, wherein the data stored in the electronic tag attached to the product contains at least data for identifying said product attached to the electronic tag and/or price information.

8. The distribution system according to claim 1, wherein the shipping site includes means for writing data to the electronic tag attached to the package.

9. The distribution system according to claim 1, wherein the shipping site includes means for reading out data from the electronic tag attached to the product disposed in the package.

10. The distribution system according to claim 1, wherein the shipping site includes means for reading out data from the electronic tag attached to the product disposed in the package, and means for writing said read out data to the electronic tag attached to the package.

11. The distribution system according to claim 1, wherein the receiving site includes a means of reading data stored on the electronic tag attached to the package.

12. The distribution system according to claim 1, wherein the receiving site includes means for reading out data stored on the electronic tag attached to the product.

13. The distribution system according to claim 1, wherein the shipping site includes means for reading out data stored on the electronic tag attached to the product, means for reading out data stored on the electronic tag attached to the package, and a means of comparing both sets of read out data.

14. The distribution system according to any of claims 1-13, wherein at least one portion of the package is composed of a material in which high frequency signals from said no-contact type wireless tag can pass there through
